(19) United States
(12) Patent Application Publication
(10) Pub. No.: US 2012/0072990 A1
(43) Pub. Date: Mar. 22, 2012

(54) COST FUNCTION FOR DATA TRANSMISSION

(75) Inventors: Gregory M. Gutt, Ashburn, VA (US); David A. Whelan, Newport Coast, CA (US); Wayne R. Howe, Irvine, CA (US); Barton G. Ferrell, Troy, IL (US); Rachel Rané Schmalzried, Garden Grove, CA (US)

(73) Assignee: THE BOEING COMPANY, Chicago, IL (US)

(21) Appl. No.: 12/887,859

(22) Filed: Sep. 22, 2010

(51) Int. Cl. G06F 21/00; G06F 17/00

(52) U.S. Cl. 726/25; 701/300

(57) ABSTRACT

A method, system, and apparatus are disclosed for cost functions for data transmission. In one or more embodiments, the method, system, and apparatus involve assigning costs associated with the data transmission corresponding to risks. The method, system, and apparatus further involve adjusting data transmission performance parameters according to the costs and the risks. The risks are associated with potential danger, harm, and/or data loss. Data transmission operation costs are related to available radio frequency (RF) bandwidth, data transmission levels of service (LoS) and/or data transmission quality of service (QoS). In at least one embodiment, each different LoS has an associated trigger boundary, which is located at a specific distance away from a risk area and indicates where and/or when to begin data transmission. The risks are related to a number of various factors including topographical features of a terrain, weather factors, conflict factors, crime factors, terrorism factors, and/or environmental region factors.

### BACKGROUND

The present disclosure relates to cost functions. In particular, it relates to cost functions for data transmission, which may be evaluated based on associated risks.

### SUMMARY

The present disclosure relates to an apparatus, method, and system for cost functions for data transmission. In one or more embodiments, the method for data transmission involves assigning costs associated with the data transmission corresponding to risks, with a processor. The method further involves adjusting data transmission performance parameters according to the costs and the risks. In some embodiments, the risks are associated with potential data loss. In one or more embodiments, the data transmission performance parameters include a rate of the data transmission.

In one or more embodiments, the risks are associated with potential danger and/or harm. In some embodiments, at least one risk has varying levels of risk severity. In at least one embodiment, at least one level of risk severity changes over time. In one or more embodiments, the level of risk severity impacts the data transmission cost. In some embodiments, a profile of an entity impacts the data transmission cost.

In at least one embodiment, the costs associated with the data transmission include data transmission operation costs. In some embodiments, the data transmission operation costs are related to an amount of available radio frequency (RF) bandwidth.

In one or more embodiments, the data transmission operation costs are related to a data transmission level of service (LoS). The data transmission LoS includes a plurality of different levels of service. In some embodiments, each different LoS has at least one associated trigger boundary.

In some embodiments, the method for data transmission further comprises providing at least one trigger boundary. Each trigger boundary is located at one or more defined distances away from a risk area and/or an entity. Also, each trigger boundary indicates where to begin data transmission, where to end data transmission, when to begin data transmission, when to end data transmission, and/or when to adjust data transmission. In one or more embodiments, at least one trigger boundary materializes, varies, and/or disappears over time. In at least one embodiment, the size of at least one trigger boundary is dependent upon the level of risk severity. In one or more embodiments, each trigger boundary is defined by a function. In some embodiments, at least one trigger boundary is overlaid on a map representation. In at least one embodiment, each trigger boundary is defined using at least one datum.

In at least one embodiment, each trigger boundary is defined by a plurality of points. In some embodiments, at least one trigger boundary is defined by an irregular shape. In one or more embodiments, the plurality of points is defined by coordinates to create a two-dimensional (2D) trigger boundary. In some embodiments, the coordinates are defined by latitude and longitude. In other embodiments, the plurality of points is defined by coordinates to create a three-dimensional (3D) trigger boundary. In at least one embodiment, the coordinates are defined by latitude, longitude, and altitude. In alternative embodiments, each trigger boundary is defined by single latitude and single longitude coordinates and a radius to create a 2D circular trigger boundary. In other embodiments, each trigger boundary is defined by single latitude, longitude, and altitude coordinates and a radius to create a 3D spherical trigger boundary. In one or more embodiments, the plurality of points is defined by various different types of coordinates including, but not limited to, geodetic coordinates, Earth-based coordinates, and/or Global Positioning System (GPS) coordinates. In other embodiments, 2D or 3D trigger boundaries may occur, vary, and/or disappear over time. For example, with severe weather or other temporal risk events, the trigger boundary may appear as weather becomes severe, it may vary with time as the severe weather increases or decreases, and/or it may disappear as the severe weather dissipates.

In one or more embodiments, the risk area is stationary. In other embodiments, the predetermined risk area is mobile. In at least one embodiment, the highest LoS has constant data transmission.

In some embodiments, the data transmission operation costs are related to a data transmission quality of service (QoS). The data transmission QoS includes a plurality of different levels. In at least one embodiment, each different QoS level has an associated data transmission LoS. In one or more embodiments, each different QoS level has an associated data transmission priority. In at least one embodiment, the data transmission priority is dependent upon an amount of available RF bandwidth. In some embodiments, each different QoS level has an associated amount of data that is transmitted during prescheduled data transmission time periods. In at least one embodiment, each different QoS level has an associated data queuing priority. In one or more embodiments, the data queuing priority is dependent upon an amount of available RF bandwidth. In at least one embodiment, each different QoS level has an associated rate of data transmission.

In one or more embodiments, the risks are related to a number of various factors including, but not limited to, topographical features of a terrain, weather factors, conflict factors, crime factors, terrorism factors, geographical areas, and/or environmental region factors. In some embodiments, the risks are derived from various types of event data including, but not limited to, historical information relating to data loss, statistical vehicle traffic information, statistical accident information, statistical criminal activity information, and/or statistical hazardous area information.

In some embodiments, the disclosed method is employed for data transmission from an aircraft. In one or more embodiments, the method uses a standard aircraft black box, which does not include a transmitter. In other embodiments, the method uses an improved aircraft black box system that includes a transmitter.

In alternative embodiments, the disclosed method is employed for data transmission from a spacecraft. In other embodiments, the method is employed for data transmission from a vehicle. Various types of vehicles may be used for the method of the present disclosure including, but not limited to, cars, boats, and/or trains. In some embodiments, the disclosed method is employed for data and/or information transmission from a personal digital assistant (PDA) device and/or other personal communicator, such as a cellular phone.

In one or more embodiments, the method for data transmission involves observing risks, with a processor. In addition, the method involves adjusting data transmission performance parameters according to the risks, with a processor. In some embodiments, the risks are associated with potential data loss. In at least one embodiment, the data transmission performance parameters include a rate of the data transmission.

In other embodiments, the method for communicating information involves identifying at least one risk area, with a processor, and determining the current location of an entity, with a processor. The method further involves calculating the distance from at least one risk area to the entity, with a processor. Also, the method involves communicating information with a transmitter when proximity of the entity to at least one risk area is within a defined value. For the disclosed method, the entity may be a various number of items including, but not limited to, a device, a vehicle, a platform, and/or a person. In one or more embodiments, the entity is stationary and/or mobile.

In one or more embodiments, the system for communicating information involves a processor and a transmitter. In some embodiments, the processor identifies at least one risk area, determines the current location of an entity, and calculates the distance from at least one risk area to the entity. In at least one embodiment, the transmitter communicates the information when proximity of the entity to at least one risk area is within a defined value. In some embodiments, the disclosed system is employed for communicating information from an aircraft. In at least one embodiment, the system further involves a standard aircraft black box, which does not include a transmitter. In other embodiments, the system also involves an improved aircraft black box system that includes a transmitter.

In alternative embodiments, the transmitter communicates the information to a ground receiver, and aircraft, and/or a satellite. Various types of satellites may be employed by the disclosed system including, but not limited to, Low Earth Orbiting (LEO) satellites, Medium Earth Orbiting (MEO) satellites and/or Geosynchronous Earth Orbiting (GEO) satellites. In at least one embodiment, the transmitter communicates the information to a terrestrial network, a network element, a ground station, a cell tower, and/or a mobile ad hoc network.

In one or more embodiments, the system for data transmission involves a processor and a transmitter. The processor assigns costs associated with the data transmission corresponding to risks. And, the transmitter adjusts data transmission performance parameters according to the costs and the risks. In some embodiments, the risks are associated with potential data loss. In at least one embodiment, the data transmission performance parameters include a rate of the data transmission.

In alternative embodiments, the processor observes risks, and the transmitter adjusts data transmission performance parameters according to the risks. In one or more embodiments, the risks are associated with potential data loss. In some embodiments, the data transmission performance parameters include a rate of the data transmission.

In some embodiments, a device for data transmission involves a processor, a graphical user interface (GUI), and a transmitter. In one or more embodiments, the processor assigning costs associated with the data transmission corresponding to risks. In at least one embodiment, the GUI displays a map that includes at least one risk area and a trigger boundary for each risk area that is used to indicate where to begin the data transmission. In some embodiments, various types of risk areas may have different levels of risk (i.e., some risk areas may be more dangerous than other risk areas). Therefore, risk areas having different levels of risk may have different trigger boundaries. Generally, risk areas having higher levels of risk have larger trigger boundary areas than risk areas having lower levels of risk.

In at least one embodiment, the GUI displays a map that includes at least one risk area and at least one trigger boundary for each risk area that is used to indicate where and/or when to end the data transmission. In some embodiments, the transmitter adjusts data transmission performance parameters according to the costs and the risks. In one or more embodiments, the risks are associated with potential data loss. In at least one embodiment, the data transmission performance parameters include a rate of the data transmission. In one or more embodiments, any system that is capable of performing basic mathematical calculations may be employed for the processor of the present disclosure. Types of systems that may be employed for the disclosed processor include, but are not limited to, application-specific integrated circuits (ASICs) and field-programmable gate arrays (FPGAs).

In one or more embodiments, a device for communicating information involves a processor and a transmitter. In at least one embodiment, the processor identifies at least one risk area, determines a current location of an entity, and calculates the distance from at least one risk area to the entity. In some embodiments, the transmitter communicates the information when proximity of the entity to at least one risk area is within a defined value.

### DRAWINGS

These and other features, aspects, and advantages of the present disclosure will become better understood with regard to the following description, appended claims, and accompanying drawings where:

FIG. 1 illustrates a diagram of a black box data transmission system, in accordance with at least one embodiment of the present disclosure.

FIG. 2 depicts a flow diagram of the disclosed method for data transmission, in accordance with at least one embodiment of the present disclosure.

FIG. 3 shows a diagram of level of service (LoS) trigger boundaries, in accordance with at least one embodiment of the present disclosure.

FIG. 4 depicts a diagram of quality of service (QoS) parameters, in accordance with at least one embodiment of the present disclosure.

FIG. 5 illustrates a pictorial representation of risk factors overlaid on a map, in accordance with at least one embodiment of the present disclosure.

FIG. 6 illustrates a pictorial representation of risk factors overlaid on a military map, in accordance with at least one embodiment of the present disclosure.

FIG. 7 is an illustration of a pictorial representation of risk factors overlaid on a commercial interactive map, in accordance with at least one embodiment of the present disclosure.

FIG. 8A depicts the use of trigger boundary established around a risk area, in accordance with at least one embodiment of the present disclosure.

FIG. 8B shows the use of a trigger boundary established around a transmitter, person, device, and/or platform location, in accordance with at least one embodiment of the present disclosure.

### DESCRIPTION

The methods and apparatus disclosed herein provide an operative system for cost functions. Specifically, this system relates to cost functions for data transmission.

The methods and apparatus of the present disclosure teach a cost modeling/risk modeling technique. In one or more embodiments, the disclosed technique is employed for aircraft black box data transmission systems. For these embodiments, the technique assigns the costs associated with the difficulty of black box retrieval against the risks associated with black box data loss.

The present disclosure relates generally to systems for transmitting information based upon the determination of various cost/risk functions. In one or more embodiments, the cost/risk function weighs the cost of transmitting specific information from a vehicle against the risk of harm to the information, device, vehicle, platform, and/or person. In at least one embodiment, the disclosed system transmits black box data (i.e. flight and cockpit data) from an aircraft using a cost/risk function that is related to the cost of providing transmission service balanced against the difficulty of recovering the black box in the event of an airplane crash in a particular region. The disclosed system may employ various Levels of Service (LoS) and Qualities of Service (QoS) to establish parameters for cost and risk.

In alternative embodiments, the disclosed technique may be used for transmission of information from other types of vehicles where the information transmission is triggered based on an increased probability of risk of harm to the vehicle. For these embodiments, the technique may be employed for transmission of information from vehicles, platforms, devices, and/or persons (with a personal digital assistant (PDA) device, including but not limited to a cellular phone) where information is triggered based on an increased probability of risk of harm to the vehicle, platform, device, and/or person. A few examples of a vehicle having an increased probability of risk of harm is a boat as it approaches an area that has a severe weather pattern, as it enters an area with shallow water and subsurface rocks, or as it enters an area that has unusual occurrences, such as the Bermuda Triangle. Another example of an increased probability of risk of harm is a person, a soldier, or a police car, or other vehicle, as it enters a historically high crime area. In an additional example, a car or train may have an increased probability of risk of harm when it enters an area that has a history of a large number of accidents. Additionally, another example of an increased probability of a risk of harm is a child, or an adult, who approaches a person who has been identified as a sex offender, approaches an identified sex offender's home address, and/or approaches an area where an identified sex offender is known typically to be located. In other embodiments, a device associated with an identified sex offender is used to trigger data transmission if the identified sex offender enters an area where children are typically known to be located. In some embodiments, the device is used in conjunction with a biometric device and/or authentication system to validate the entity.

The risk of harm, which in some embodiments relates to the difficulty and likelihood of black box retrieval and affects the associated black box search and retrieval costs, is related to a number of various topographical features. These topographical features include, but are not limited to, water instance and depth, harsh terrain, historical airplane crash data, black box retrieval data, environmental regions, weather, international factors, political factors, and/or conflict factors.

In one or more embodiments, the disclosed cost-sensitivity analysis tool allows a transmission service provider to adjust data transmission and performance parameters in order to account for different Levels of Service (LoS) and Quality of Service (QoS). The tool also allows the provider to recognize the data transmission cost as a function of the LoS and QoS parameters.

One advantage of the disclosed system and its associated black box data transmission architecture is that it uses various Levels of Service (LoS) to trigger transmission of information. The system employs a cost-benefit/risk-mitigation analysis tool. In one or more embodiments, the cost of the service, which is based on the available satellite communications bandwidth and/or other available radio frequency (RF) bandwidth, is weighed against the risk of difficulty of black box or other device retrieval. The disclosed system tends to use primarily constellation bandwidth over sparsely populated areas where the cost of bandwidth is low and available. As such, this system makes it more economically feasible for airline carriers to implement the disclosed system versus other existing systems that transmit data on an ongoing, continuous basis. The transmission of a continuous data stream requires a supporting infrastructure to transmit and store massive amounts of data, much of which may not be pertinent to flight investigations or other uses of this system.

In at least one embodiment of the present disclosure, black box data packets are transmitted from the airplane to a Low Earth Orbiting (LEO) satellite. A scheduler schedules the data transmission according to the airplane's self-identified LoS and/or QoS. It should be noted that in some cases, the higher risk areas may be inversely related to the cost of data transmission (e.g., An airline carrier flying over the deep ocean (i.e. a high risk area) is also flying over an area of low population and, as such, the total amount of communications traffic is small. This low level of communications traffic leads to a small communications cost.). In an exemplary scenario of the disclosed system, an airline carrier may have an identified LoS of Gold with a high QoS. As the particular airplane traveling internationally approaches a Gold data transmission trigger boundary that is located at a defined distance from the ocean (i.e. the trigger distance), the plane begins transmitting black box data. As the aircraft converges on land, the data transmission is triggered to be terminated, but then may be re-triggered to begin again by another trigger boundary.

There are three main aspects to the system of present disclosure. The three main aspects are (1) transmission triggers, (2) levels of service (LoS), and (3) quality of service (QoS). The first aspect of the present disclosure is transmission triggers. Transmission triggers are established to identify areas, occurrences, situations, and/or other instances where there is increased risk of harm. A transmission trigger is used to trigger the start of data transmission.

The second aspect of the present disclosure is LoS. Various LoS are established according to the degree or probability of risk of harm, the cost of providing the service, and/or the pricing of the service. For example, the degree or probability of a risk of harm can be dependent upon the distance from a high-risk area, and the cost of providing the service can be dependent up varying transmission costs.

The third aspect of the present disclosure is QoS. Different levels of QoS are established for the disclosed system. These levels may be affected by the different risk of harm levels, the different costs, and/or the different pricing. The levels of QoS can control the amount of information sent, the priority with which the information is sent, the immediacy or delay with which the information is sent, and/or the determination of which specific information is sent.

In order to understand better the embodiments of the present disclosure that employ aircraft black boxes as well as the advantages of these embodiments, a brief background relating to aircraft black boxes and black box retrieval is as follows. The term “black box” refers to two separate, orange colored boxes which house separately a flight data recorder (FDR) for recording aircraft performance parameters and a cockpit voice recorder (CVR) for collecting all cockpit noise, which includes pilot and other communications between the crew and air traffic controllers as well as mechanical noises. These boxes are built to withstand extreme conditions, such as those caused by violent airplane crashes. The boxes are tested to verify survivability through the following testing parameters: 3,400 Gs crash impact; 500 pounds (lbs) pin drop; 5,000 pounds per square inch (psi) static crush; 2,000 degrees Fahrenheit (F.) fire for one hour, deep-sea submersion for 24 hours; salt-water submersion for 30 days, and aviation fluid immersion.

It should be noted that black box and black box system designs have seen some recent improvements. These newly improved black box and black box system designs have been primarily integrated into newly built airplanes, rather than been retrofitted in existing airplanes. Black box and black box system designs will continue to improve over time. Improved designs include black boxes that include their own power systems as well as their own image and video capture systems. While a specific aircraft black box data transmission system is taught in the present disclosure, those skilled in the art can recognize that future improved black box and black box system designs may be employed by the disclosed cost/risk functions associated with the transmission of data.

From 1959 to 2008, there were 1,630 commercial jet accidents worldwide, of which 582 included fatalities. To aid in post-accident investigations, the United States Federal Aviation Administration (FAA) requires commercial jets to be built with at least one black box in the case of such an event. Ninety-two percent (92%) of fatal accidents during this period of time occurred during or prior to climbing or during or after descent, which improves the likelihood of black box retrieval post-accident since the aircraft crash site is in a generally known vicinity. However, eight percent (8%) of the fatal accidents occurred during cruise altitude. Unfortunately, in some cases, these intensely engineered boxes cannot withstand the extreme crash and post-crash conditions, cannot be retrieved, and/or cannot be located. Even after retrieval, the data contained on the black boxes may have been compromised or the black boxes may not have recorded the last several minutes leading up to the plane crash due to failure in the systems supporting the boxes functionality, such as the power system.

While black boxes themselves are relatively low in cost at approximately $8000-$10,000 per box (or $16,000-$20,000 per set of boxes (e.g., flight and cockpit data recorders) for a commercial jetliner), it is the non-recovery of these boxes which can lead to millions of dollars spent on searching for them and additional post-crash investigations if not located or when data has been impacted. A single incident, such as Air France Flight No. 447, which crashed over the deep Atlantic Ocean and in which the black box was never recovered, can represent billions in dollars of liability for airline carriers, insurers, and manufacturers. For example, the Transportation Safety Board of Canada undertook a 4.5 year investigation at a cost of $39,000,000 in order to attempt to determine the cause of the crash of SwissAir Flight No. 111 that occurred off the coast of Nova Scotia in which the last approximately six (6) minutes of the flight was not recorded by the black boxes.

In the following description, numerous details are set forth in order to provide a more thorough description of the system. It will be apparent, however, to one skilled in the art, that the disclosed system may be practiced without these specific details. In the other instances, well known features have not been described in detail so as not to unnecessarily obscure the system.

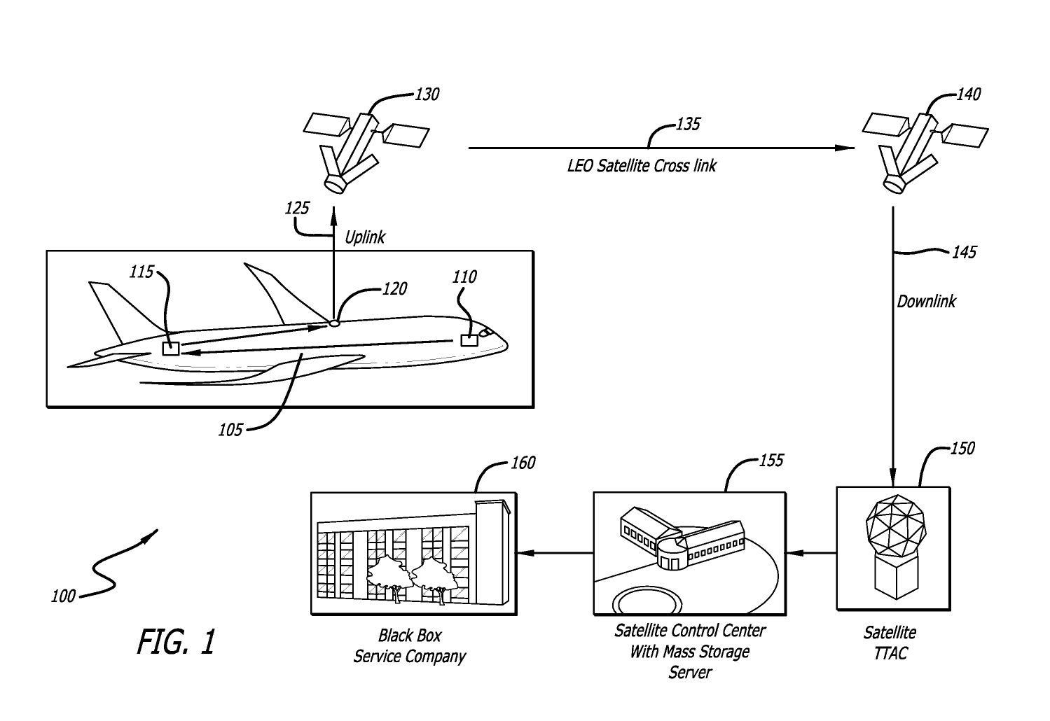

FIG. 1 illustrates a diagram of a black box data transmission system 100, in accordance with at least one embodiment of the present disclosure. In this figure, the aircraft 105 is shown to contain a black box 110. The black box 110 includes a flight data acquisition system as well as a flight voice recorder. Various types of black boxes may be employed by the disclosed system including, but not limited to, standard black boxes, which are tied into the aircraft power system; next generation black boxes, which have their own battery systems; and/or improved black box data transmission systems that continuously transmit data.

In this figure, the aircraft 105 is shown also to include a satellite transceiver 115. In at least one embodiment of the present disclosure, when the aircraft 105 crosses a trigger boundary, the satellite transceiver 115 is triggered to start transmission of information that is recorded by the black box 110. The information is transmitted by an antenna 120 on the aircraft 105 via an uplink 125 to a LEO satellite 130. Types of satellites that may be employed by other embodiments of the present disclosure include, but are not limited to, medium earth orbit (MEO) satellites and/or geosynchronous earth orbit (GEO) satellites.

After the LEO satellite 130 receives the information, the LEO satellite 130 transmits the information to another LEO satellite 140 in its constellation via a crosslink 135. After the other LEO satellite 140 receives the information, it transmits the information to a satellite tracking, telemetry, and control (TTAC) ground station 150 via a downlink 145. The satellite TTAC ground station 150 transfers the information to a satellite control center 155, which includes a mass storage server. The satellite control center 155 then transfers the information to a black box service company 160 for analysis of the information.

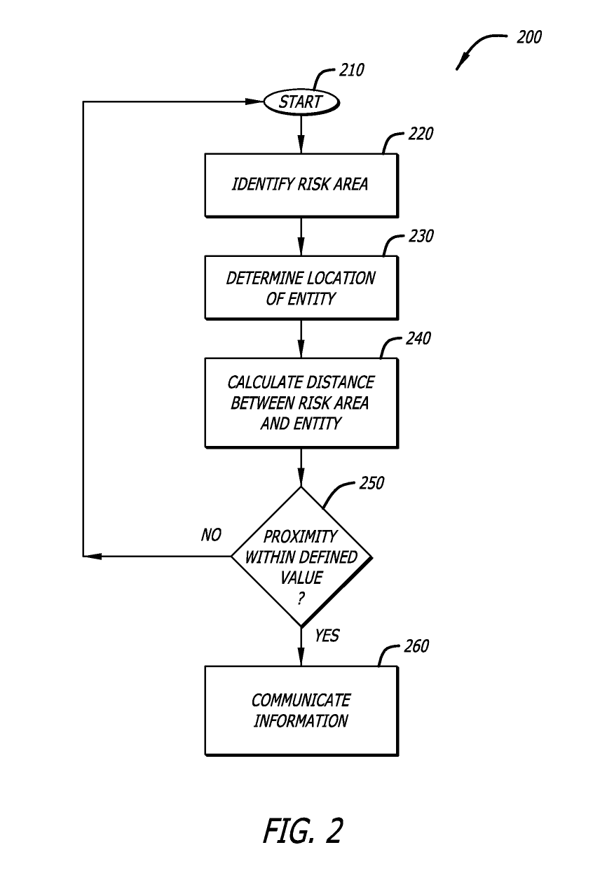

FIG. 2 depicts a flow diagram 200 of the disclosed method for data transmission, in accordance with at least one embodiment of the present disclosure. In particular, this figure illustrates the general sequence of logic that is performed for the disclosed method for data transmission. As shown in this figure, a processor first starts 210 the logic sequence by initially identifying at least one risk area of interest 220. In one or more embodiments, the risk area is a particular location, which has risks that are associated with potential danger, harm, and/or data loss. After the processor identifies at least one risk area 220, the processor then determines the location of at least one entity 230. In at least one embodiment, the entity is a device, a vehicle, a platform, and/or a person. Also, in one or more embodiments, the entity is stationary and/or mobile.

After the processor determines the location of at least one entity 230, the processor calculates the distance between each risk area and each entity 240. The processor must then determine whether the distance between each risk area and each entity is within a defined value (i.e. if any of the entities are in proximity to any of the risk areas within a defined value) 250. If the processor determines that any of the entities are in proximity to any of the risk areas within the defined value 250, the processor will cause at least one transmitter to begin transmission of information 260. However, if the processor determines that none of the entities are in proximity to any of the risk areas within the defined value 250, the sequence of logic will be repeated from the start 210.

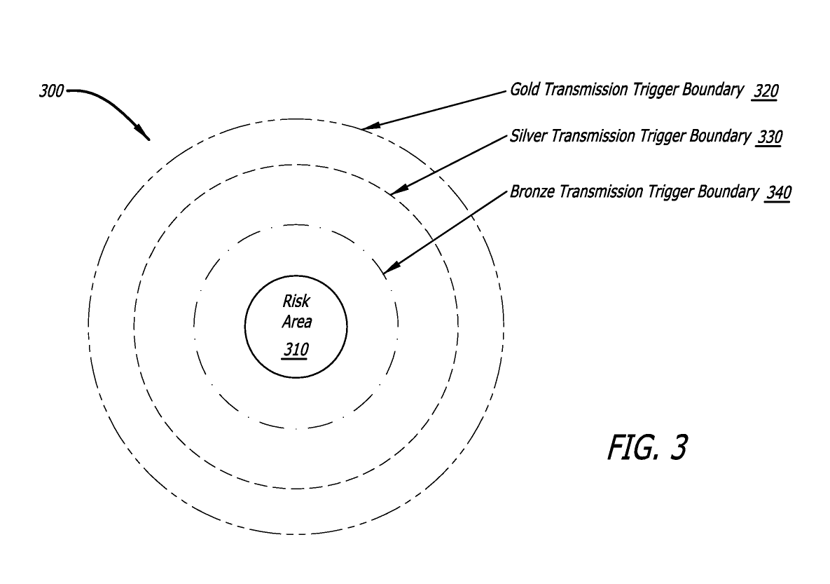

FIG. 3 shows a diagram of level of service (LoS) trigger boundaries 300, in accordance with at least one embodiment of the present disclosure. In this figure, various trigger boundaries 320, 330, 340 are plotted at specified distances from a risk area 310. In particular, a Gold transmission trigger boundary 320, a Silver transmission trigger boundary 330, and a Bronze transmission trigger boundary 340 are shown in this figure. The three levels of trigger boundaries (i.e. Gold, Silver, and Bronze) in this figure represent the different LoS that the aircraft may have. For example, if the aircraft has a Gold LoS, when the aircraft crosses the Gold transmission trigger boundary 320, the aircraft will start to transmit data. In addition, after the aircraft crosses the risk area 310 and then crosses the corresponding Gold transmission trigger boundary 320, the system will stop transmitting data. It should be noted that other embodiments of the present disclosure may have more or less than three LoS.

In one or more embodiments, an example of a set of LoS includes a descending level structure of Platinum (e.g., having continuous transmission service), Gold, Silver, Bronze, and Copper (e.g., having no transmission service) levels. These levels may be based on earth-based data triggers and/or communications bandwidth availability triggers. Table 1 displays an example set of sub-parameters for these LoS levels. This exemplary table may use alternative LoS parameters and QoS parameters. Note that QoS service capabilities may be mapped to alternate LoS. Note that QoS parameters are discussed in more detail in Table 3 and its corresponding paragraphs.

TABLE 1
Exemplary Levels of Service (LoS) and Characteristics

| Exemplary | | |
|---|---|---|
| Level of | Exemplary LoS | |
| Service | Trigger Characteristics | Exemplary QoS Level Characteristics |
| Platinum | Coverage area triggers: All locations, | QoS Triggers: Always transmit |
| | Always Transmit. | continuously, all information, at highest |
| | Taxi/Descent/Distance: Transmit | priority whatever location. |
| | continuously prior to taxi, during flight, and | FDR bits: Yes, e.g. 300-700 parameters |
| | after landing. | CVR bits: Yes, 4 channels |
| | | Image/Video system bits: Yes |
| Gold | Coverage area triggers: Largest diameter | QoS Triggers: When LoS triggers |
| | earth-based triggers (i.e., larger diameter | transmission, then transmit at highest |
| | triggers black box data transmission sooner | priority (highest priority queue) whenever |
| | and allows transmission for a longer period | LoS triggers. |
| | of time). | FDR bits: Yes, e.g. 300-700 parameters |
| | Trigger_Distance = Gold_Trigger_Distance = | CVR bits: Yes, 4 channels |
| | e.g., 200 kilometers from high-risk area. | Image/Video system bits: Yes |
| | Taxi/Descent Time/Distance: Transmit for | |
| | X_{Gold} minutes starting prior to taxi and | |
| | again for X_{Gold} minutes on descent (or when | |
| | <=Y_{Gold} distance from LoS Function Data | |
| | Transmission Triggers - see Table 3.) | |
| Silver | Coverage area triggers: Second largest | QoS Triggers: When LoS triggers |
| | diameter earth-based triggers. | transmission, then medium priority. |
| | Trigger_Distance = | Alternatively - When LoS triggers |
| | Silver_Trigger_Distance = e.g., 100 | transmission, then if in Low Cost |
| | kilometers from high-risk area. | transmission communication area |
| | Taxi/Descent/Distance: Transmit for | (bandwidth available at low-cost), then |
| | <=X_{Silver} minutes starting prior to taxi and | transmit at High Priority (high priority |
| | again for <= X_{Silver} minutes on descent (or | queue); elseif in High Cost Communication |
| | when <=Y_{Silver} distance from LoS Function | Transmission area (bandwidth unavailable |
| | Data Transmission Triggers - see Table 3.) | except at high cost), then transmit at low |
| | | priority (best effort priority queue) |
| | | whenever LoS triggers. |
| | | FDR bits: Yes, e.g. 150-299 parameters |
| | | CVR bits: Yes, 4 channels |
| | | Image/Video system bits: e.g., No |
| Bronze | Coverage area triggers: Smallest diameter | QoS Triggers: When LoS triggers |
| | earth-based triggers. | transmission, then transmit at low priority |
| | Trigger_Distance = | (best effort priority queue) whenever LoS |
| | Bronze_Trigger_Distance = e.g., 20 | triggers. |
| | kilometers from high-risk area. | FDR bits: Yes, e.g. 88 (lowest level |
| | Taxi/Descent/Distance: Transmit for | required by law for standard black boxes) |
| | <=X_{Bronze} minutes starting prior to taxi and | parameters |
| | again for <=X_{Bronze} minutes on descent (or | CVR bits: Yes, 4 channels |
| | when <=Y_{Bronze} distance from LoS Function | Image/Video system bits: e.g., No |
| | Data Transmission Triggers - see Table 3) | |
| Copper | No black box data transmission service on | No transmission |
| | plane, only standard black boxes. | |

An example pseudocode of LoS transmission triggers is shown below in Table 2. The following LoS transmission trigger coding includes topographic (e.g., water instance and harsh terrain), environmental region, and/or political conflict parameters.

TABLE 2
Exemplary Pseudocode of LoS Triggers

%LOS FUNCTION DATA TRANSMISSION TRIGGER
% Exemplary permanent params
%Trigger_Distance (Platinum) = 40080 km; (Platinum
Trigger_Distance could be % defined in lieu current code set up)
Trigger_Distance (Gold) = 200 km;
Trigger_Distance (Silver) = 100 km;
Trigger_Distance (Bronze) = 20 km;
Trigger_Distance (Copper) = 0 km;
Transmit = False;
% Determine LoS and trigger distance
Determine Level_of_Service (Platinum, Gold, Silver,
Bronze, Copper);
Determine Trigger Distance (Level_of_Service);
% Determine current location
Determine Current_Location;
% Check LoS level to see if data transmission is continuous
if (Level_of_Service = Platinum)
then (Transmit=True);
% Determine whether vehicle is within trigger distance from risk area
elseif (Distance_from
Current_Location to_any_following_situation <=
Trigger_Distance (Level of Service) )
(
% if any of these conditions are true, then transmit
% Determine nearest risk situations via LoS checks
% Mountainous region check
if (groundelev>1000) & (slope>30)
then (Transmit=True) AND exit;
% Water region check with margin of error and water depth check
elseif (groundelev<=sealevel+10feet) & (waterdepth>400)
then (Transmit=True) AND exit;
% Environmental region check for arctic and Antarctic
elseif (lat>deg) OR (lat<deg)
then (Transmit=True) AND exit;
% International political and war conflict region check
elseif (lat>deg) & (lat<deg) & (long>deg) & (long<deg)
then (Transmit=True) AND exit;
% Airport vicinity or altitude from ground check
elseif (altitude − groundelev < X)
then (Transmit=True) AND exit;
% Bad weather check (based on weather map gridded)
elseif (lat>deg) & (lat<deg) & (long>deg) & (long<deg)
then (Transmit=True) AND exit;
% High level of airplane traffic check (based on air traffic map gridded)
elseif (lat>deg) & (lat<deg) & (long>deg) & (long<deg)
then (Transmit=True) AND exit;
Endif
)
% Data transmission check
if (Transmit=False)
DoNotTransmit;
elseif (Transmit=True)
(
% SEE QOS FUNCTION IN TABLE 4 IF QOS IS ALSO UTILIZED
if (QoS_Service)
then Transmit_QoS;
elseif (NoQoS_Service)
then Transmit;
Endif
)
% END LOS FUNCTION DATA TRANSMISSION TRIGGER

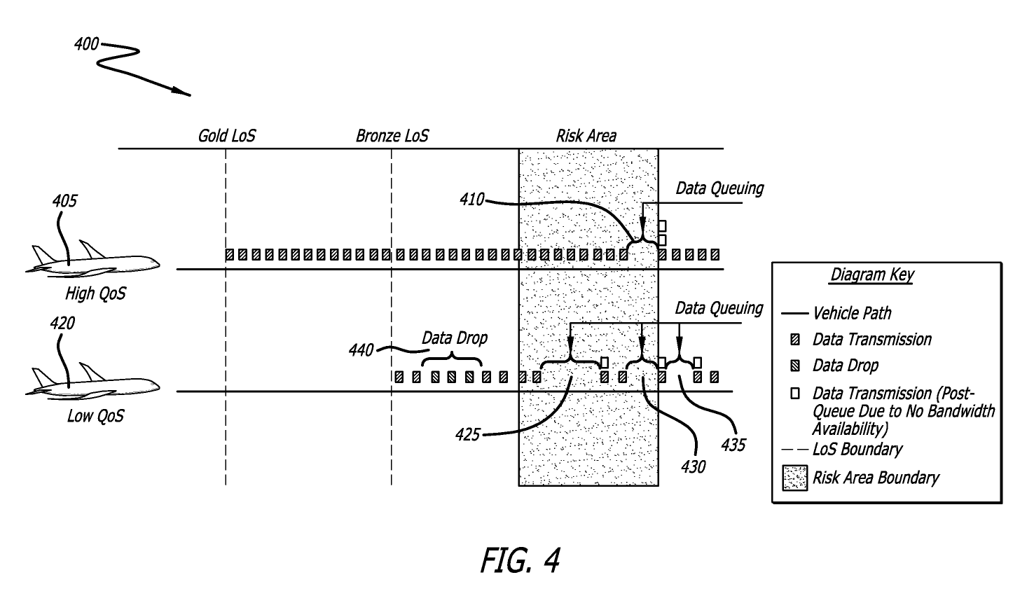

FIG. 4 depicts a diagram of quality of service (QoS) parameters 400, in accordance with at least one embodiment of the present disclosure. In this figure, the airplane 405 with a high level of QoS also has a Gold LoS. As such, the figure shows that airplane 405 starts transmitting data at the Gold LoS boundary. The figure also shows that when airplane 405 is flying over the risk area, the data transmission experiences problem with available bandwidth 410.

Also in this figure, the airplane 420 with a low level of QoS has a Bronze LoS. Thus, it is shown that airplane 420 starts transmission of data at the Bronze LoS boundary. Also shown in this figure, since airplane 420 has a low level of QoS, airplane 420 has more instances of problems with available bandwidth 425, 430, 435 than airplane 405. In addition, airplane 420 also experiences instances of data drop 440 during its transmission.

In one or more embodiments, an example set of QoS levels includes a descending structure of High, Medium, and Low levels that are based on information transmission priority, and/or data queuing priority, and may be influenced by available bandwidth. QoS data triggers associated with LoS parameters, as shown in Table 1, may typically occur when available bandwidth is particularly low or high (e.g., in areas such as oceans and mountainous terrain). The following table depicts an example set of QoS sub-parameters.

TABLE 3
Exemplary Quality of Service and Data Transmission Characteristics

| Exemplary | |
|---|---|
| Qualities | |
| of Service | |
| (Priority) | Exemplary Data Transmission |
| High | Pre-scheduled channels, data transmitted immediately |
| | or ASAP when available, i.e., High QoS. |
| | Max Queue Data Packets: None, or small for more immediate |
| | transmission, but small or no drop characteristics. |
| | Max Time Duration Once Data Packets Queue: Not |
| | Applicable. |
| Medium | Not pre-scheduled channels, data transmitted after high QoS |
| | data and before low QoS data, i.e., Medium QoS. Or, |
| | data transmitted when high bandwidth is available at |
| | low cost; and data not transmitted when low or no |
| | bandwidth is available or high cost. |
| | Max Queue Data Packets: Y, some drop characteristics |
| | may be acceptable. |
| | Max Time Duration Once Data Packets Queue: Z minutes. |
| Low | Not pre-scheduled, data transmitted when bandwidth or |
| | space available (in between calls) and/or low-cost, i.e., |
| | Best Effort. |
| | Max Queue Data Packets: >Y, drop characteristics acceptable. |
| | Max Time Duration Once Data Packets Queue: >Z minutes. |

In at least one embodiment, the system may include an intelligent scheduler either on the airplane transmitter, on the supporting LEO satellite assets (e.g., satellites in a satellite constellation such as Iridium), or on other communication links that determines when bandwidth is available and uses this intelligence to schedule data transmission during the periods of time when there is bandwidth availability. The intelligent schedulers are used when the data is transmitted from the airplane to the satellite asset or other communication system, and subsequent cross-linking may be required to allow for transmission of the data to the ground.

In one or more embodiments, high priority data packets with a similar QoS level could be pre-scheduled in advance with a higher associated cost. Low priority data packets with a corresponding low QoS level could be transmitted as bandwidth becomes available. Furthermore, after data packets begin to queue up there could be additional triggers based on amount of packets queued as well as after a certain period of time has passed. Some data may be determined to be unneeded and/or stale if the plane is operating within normal bounds and/or sufficient time has passed since it was captured. In these cases, the data may be dropped prior to being transmitted.

An example pseudocode of QoS transmission triggers is shown below in Table 4. The following QoS transmission trigger pseudocode utilizes the priority triggers that were defined above.

TABLE 4
Exemplary Pseudocode of QoS Transmission

%QOS FUNCTION DATA TRANSMISSION TRIGGER (Transmit_QoS)
(
% Determine QoS level
Determine Quality_of_Service (High, Medium, Low);
% QoS Sub_Param Definition
if (Trigger_QoS = High)
(
Prescheduled = e.g., Yes;
Max Queue = e.g., 0;
Max Queue Duration = e.g., 0 sec;
)
elseif (Trigger_QoS = Medium)
(
Prescheduled = e.g., No;
Max Queue = e.g. 1800;
Max Queue Duration = e.g. 300 sec;
)
elseif (Trigger_QoS = Low)
(
Prescheduled = e.g., No;
Max Queue = e.g. 5000;
Max Queue Duration = e.g. 600 sec;
)
% Bandwidth availability check
Determine Bandwidth_Available;
if (Bandwidth_Available = No)
(
while (Bandwidth_Available = No)
then Queue;
)
elseif (Bandwidth_Available = Yes)
(
% QoS level check
if (Trigger_QoS = High)
(
% Identify pre-scheduled channels
Determine PreSch_Channels (Trigger_QoS = High)
% Determine_Nearest_High_Cost_Communication_Area
Determine Nearest_High_Cost_Communication_Area;
if(Distance_from Current_Location to_Nearest_High_Cost_Communication_Area <= Trigger_Distance
(Level of Service) )
(
if (Quality_of_Service = High)
(then Transmit (PreSch_Channels)
endif;
elseif (Quality_of_Service = Medium)
(
if (Queue_High > 0)
(while (Max_Queue (Med) < e.g. 1800) AND (Max_Duration (Med) < e.g. 300 sec)
then Queue (Med)
then DoNotTransmit;)
elseif (Queue_High = 0)
(while (Max_Queue (Med) >= e.g. 1800) AND (Max_Duration (Med) >= e.g. 300 sec)
then Transmit (QoS = Med);
endif;
)
% alternatively, for Medium Service, test if Available_Bandwidth = Expensive, then
% put in low priority queue; elseif Available_Bandwidth = Inexpensive put in
% high priority queue; Transmit;
elseif (Quality_of_Service = Low)
(
if (Queue_Med > 0)
(while (Max_Queue (Low) < e.g. 5000) AND (Max_Duration (Low) < e.g. 600 sec)
then Queue (Low)
then DoNotTransmit;)
elseif (Queue_Med = 0)
(while (Max_Queue (Low) >= e.g. 5000) AND (Max_Duration (Low) >= e.g. 600 sec)
then Transmit (QoS = Low);
% alternatively, for all service levels, queued data could be dropped if determined to be stale due increased
queue from unavailable bandwidth
endif;
)
elseif (Level_of_Service = Copper)
(then DoNotTransmit
endif;
)
elseif(Distance_from Current_Location to_Nearest_High_Cost_Communication_Area = 0 )
(
if (Quality_of_Service = High)
(then Transmit (PreSch_Channels)
endif;
elseif (Quality_of_Service = Medium)
(
then Queue (Med)
then DoNotTransmit;)
elseif (Queue_High = 0)
then Transmit (QoS = Med);
)
endif;
)
Endif
%END QOS FUNCTION DATA TRANSMISSION TRIGGER (Transmit_QoS)

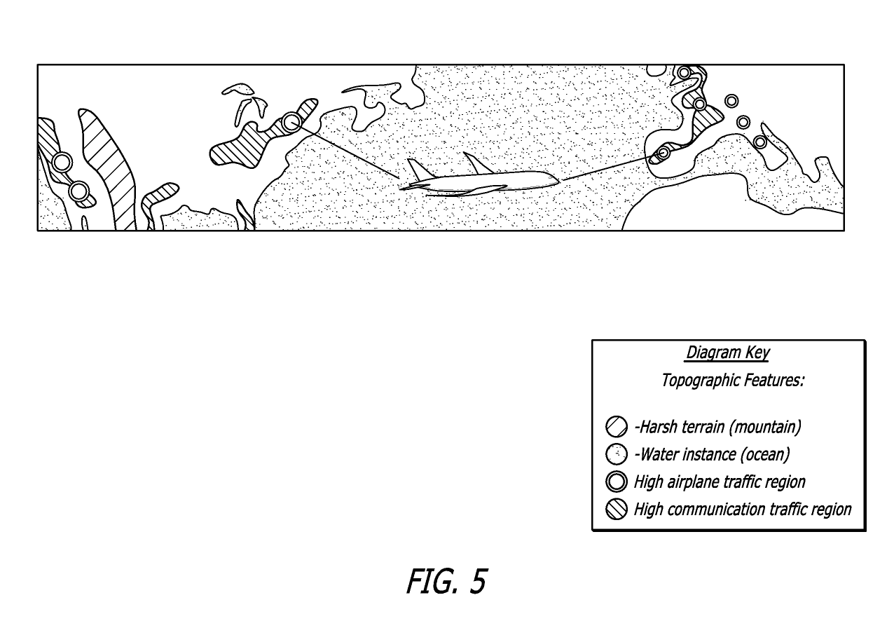

FIG. 5 illustrates a pictorial representation of risk factors overlaid on a map, in accordance with at least one embodiment of the present disclosure. In this figure, various topographical regions relating to risks associated with data loss are shown on a map of Earth. These regions include harsh terrain regions, water instances regions, high airplane traffic regions, and high communication traffic regions.

In one or more embodiments of the present disclosure, there are a various number of risk factors that are associated with potential danger, harm, and/or data loss that the cost function weighs. These risk factors include, but are not limited to, topographical features, historical airplane crash factors, black box retrieval data, weather factors, international and political conflict factors, terrorism factors, and/or environmental regions. Topographical features include, but are not limited to, water instance and depth as well as harsh terrain. For example, searches for black boxes from airplanes that crash into the ocean have a high level of risk because they often carry a high data retrieval cost and a lower likelihood of black box data retrieval.

Historical airplane crash and black box retrieval data are other risk factors that the cost function weighs. Historically, there is a high incidence of crashes that occur prior to and after starting the descent from cruise altitude to landing and, thus, this high incidence of crashes leads to a high risk of harm. Historical information may include data that is mined to aid in identifying areas of higher incident rates and other data that may help to improve the cost function model.

In addition, weather factors, such as thunderstorms and wind shear increase the likelihood of aircraft accidents, thereby leading to a high risk of harm. In particular, wind shear, which is a variation of wind over a distance, has been noted to be a significant contributing factor to the take-off and landing accidents, which involve a large loss of life.

Also, international and political conflict factors are other risk factors that the cost function weighs. An example of a political conflict factor that could lead to a risk of harm could include the scenario where a particular airline carrier departing from country A with plans of arrival in country C has an accident in country B. In this scenario, country B has a stressed political relationship with country A and/or C and, thus, this causes a difficulty in being able to retrieve the black box from country B.

Terrorism factors are additional factors that can cause a risk of harm. Being able to having quick access to data in situations where terrorism might be involved is crucial since criminal leads diminish with time. Terrorists typically target popular public locations and/or military or civil headquarters. Thus, these areas may be considered to be areas having increased levels of risk.

In addition, environmental regions contribute to risks of harm. Areas such as the Antarctica or the Sahara desert, which have intense environmental conditions, may be sparsely populated and have harsh environmental factors that could increase the difficulty in retrieving a black box. In addition, environmental occurrences such as the 2010 Eyjafjallajokull volcano eruption in Iceland could be included as a risk factor because the difficulty in searching for a black box could be substantially increased if air quality and/or visibility were degraded due to such an occurrence.

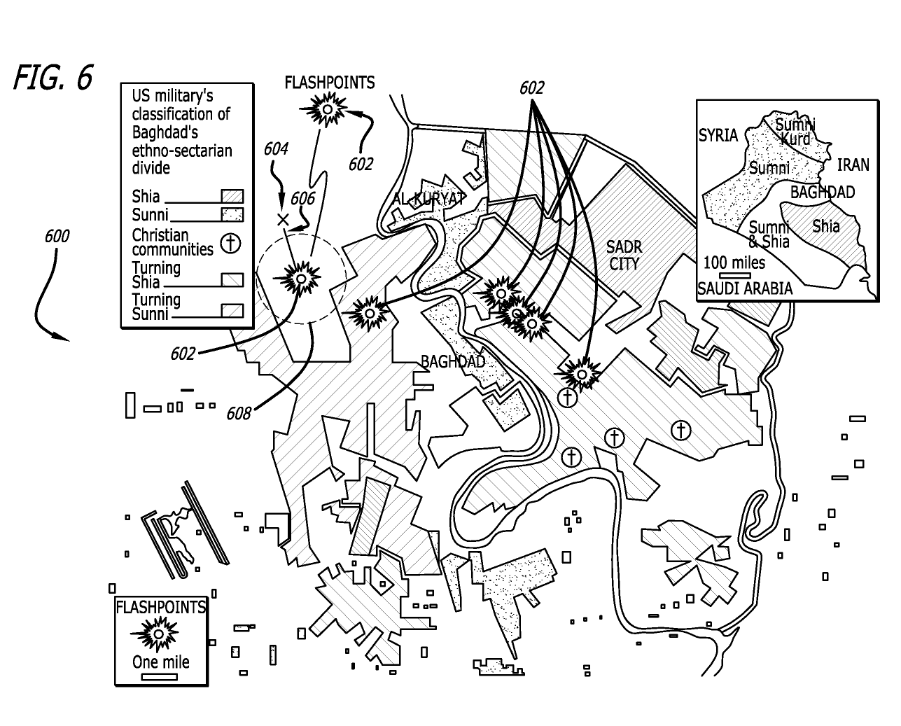

FIG. 6 illustrates a pictorial representation of risk factors overlaid on a military map 600 with military risk locations or flashpoints 602 identified on the map 600. The map 600 may be associated with a graphical user interface (GUI), which may be interactive. The risk locations 602 may be stationary and/or mobile. A trigger boundary 608 is identified surrounding a particular risk area 602. When a soldier's location 604 is within the predetermined proximity 606 of the particular, military, risk area 602, as determined by trigger boundary 608, an alarm alerts the soldier and information such as video, audio, data, location and/or other information is transmitted from the soldier's person, device, vehicle, platform, and/or other transmission equipment to a receiver on a satellite, aircraft, vehicle, and/or ground station (not shown).

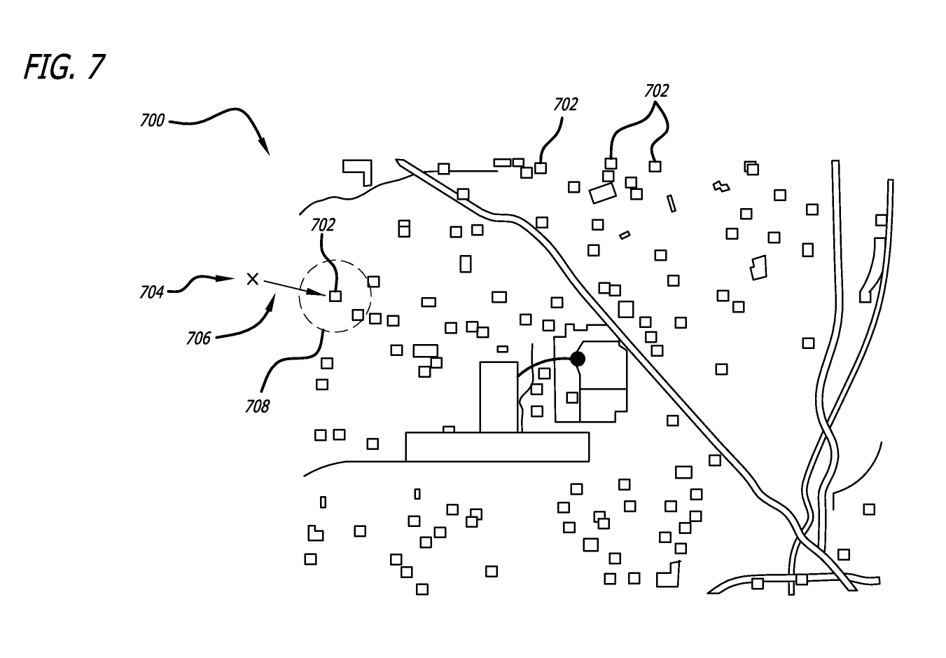

FIG. 7 shows a pictorial representation of risk factors overlaid on a commercial interactive map 700 of registered sex offenders, other criminals, and/or other high-risk persons. The map 700 may be associated with a graphical user interface (GUI), which may be interactive. The risk locations 702, which are denoted by small boxes depicted in the figure, may be stationary and/or mobile. The registered sex offenders' physical addresses and/or mobile locations are shown as risk locations 702 identified on the map 700. These locations 702 may be determined by using devices such as Global Positioning System (GPS) ankle bracelets. In addition, the risk locations 602 may be areas of previous crime scenes and/or prior accident sites. A trigger boundary 708 is identified surrounding each risk area 702. When the child's, or other potential victim's, location 704 is within the predetermined proximity 706 to a particular risk area 702, as determined by trigger boundary 708, an alarm alerts the child, or other potential victim, and information such as video, audio, data, location and/or other potential information is transmitted from the child's, or victim's, person, device, vehicle, platform, and/or other transmission equipment to a receiver on a satellite, aircraft, vehicle, and/or ground station (not shown).

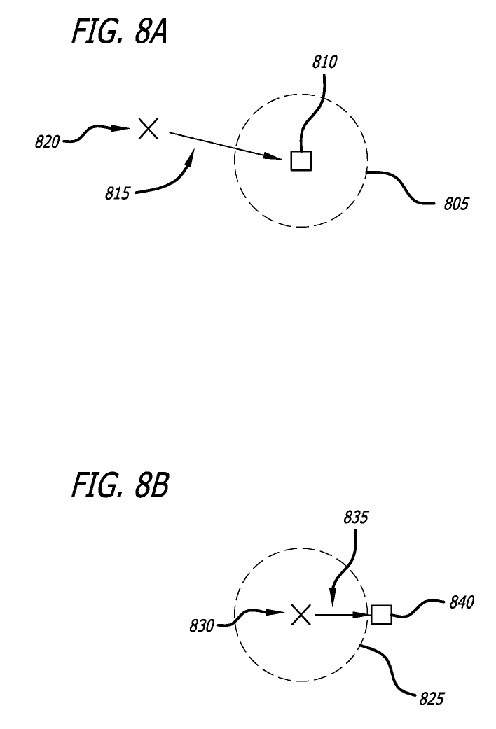

FIGS. 8A and 8B illustrate two different embodiments for implementing the trigger boundaries of the present disclosure. FIG. 8A depicts a trigger boundary 805 that surrounds a risk area or risk location 810. In this figure, the proximity computation 815 may be determined to be the distance between the transmitter, person, device, and/or platform location 820 and the trigger boundary 805. This disclosed embodiment may require intense processing calculations because for some cases there will be many trigger boundaries 805 around many risk locations 810.

FIG. 8B depicts a trigger boundary 825 that surrounds the transmitter, person, device, and/or platform location 830. In this figure, the proximity computation 835 may be determined to be the distance between the risk location 840 and the trigger boundary 825. This embodiment may require less intensive processing calculations than the embodiment of FIG. 8A because in this embodiment there is only a single trigger boundary 825, which is around the transmitter, person, device, and/or platform location 830. The design tradeoffs between the embodiments depicted in FIGS. 8A and 8B may depend upon the number of risk locations 810, 840 to be computed and/or the speed at which the transmitter is moving, which will affect the number of trigger boundary recalculations that are required.

Although certain illustrative embodiments and methods have been disclosed herein, it can be apparent from the foregoing disclosure to those skilled in the art that variations and modifications of such embodiments and methods can be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

We claim:

1. A method for data transmission, the method comprising:
assigning costs associated with the data transmission corresponding to risks, with a processor.

2. The method for data transmission of claim 1, wherein the method further comprises adjusting data transmission performance parameters according to the costs and the risks.

3. The method for data transmission of claim 2, wherein the data transmission performance parameters include a rate of the data transmission.

4. The method for data transmission of claim 1, wherein the risks are associated with at least one of potential danger, potential data loss, and harm.

5. The method for data transmission of claim 1, wherein at least one risk has varying levels of risk severity.

6. The method for data transmission of claim 5, wherein the level of risk severity impacts the data transmission cost.

7. The method for data transmission of claim 1, wherein a profile of an entity impacts the data transmission cost.

8. The method for data transmission of claim 1, wherein the costs associated with the data transmission include data transmission operation costs.

9. The method for data transmission of claim 8, wherein the data transmission operation costs are related to an amount of available radio frequency (RF) bandwidth.

10. The method for data transmission of claim 8, wherein the data transmission operation costs are related to a data transmission level of service (LoS).

11. The method for data transmission of claim 10, wherein the data transmission LoS includes a plurality of different levels of service.

12. The method for data transmission of claim 11, wherein each different LoS has at least one associated trigger boundary.

13. The method for data transmission of claim 1, wherein the method further comprises providing at least one trigger boundary, wherein each trigger boundary is located at one or more defined distances away from at least one of a risk area and an entity.

14. The method for data transmission of claim 13, wherein each trigger boundary indicates at least one of where to begin data transmission, where to end data transmission, when to begin data transmission, when to end data transmission, and when to adjust data transmission.

15. The method for data transmission of claim 13, wherein the at least one trigger boundary is overlaid on a map representation.

16. The method for data transmission of claim 13, wherein each trigger boundary is defined by at least one of at least one datum and an irregular shape.

17. The method for data transmission of claim 13, wherein each trigger boundary is defined by a plurality of coordinates.

18. The method for data transmission of claim 17, wherein the coordinates are defined by at least one of latitude, longitude, and altitude.

19. The method for data transmission of claim 17, wherein the plurality of coordinates is defined by at least one of geodetic coordinates, Earth-based coordinates, and Global Positioning System (GPS) coordinates.

20. The method for data transmission of claim 8, wherein the data transmission operation costs are related to a data transmission quality of service (QoS).

21. The method for data transmission of claim 20, wherein the data transmission QoS includes a plurality of different levels.

22. The method for data transmission of claim 21, wherein each different QoS level has at least one of an associated data transmission LoS, an associated data transmission priority, an associated amount of data that is transmitted during prescheduled data transmission time periods, an associated data queuing priority, and an associated rate of data transmission.

23. The method for data transmission of claim 1, wherein the risks are related to at least one of topographical features of a terrain, weather factors, conflict factors, crime factors, terrorism factors, and environmental region factors.

24. The method for data transmission of claim 1, wherein the risks are derived from at least one of vehicle traffic information, accident information, criminal activity information, hazardous area information, and historical information relating to data loss.

25. The method for data transmission of claim 1, wherein the method is employed for data transmission from at least one of an aircraft, a spacecraft, a vehicle, a car, a boat, a train, a personal digital assistant (PDA), and a cellular phone.

26. The method for data transmission of claim 1, wherein the method uses at least one of a standard aircraft black box, which does not include a transmitter, and an improved aircraft black box system that includes a transmitter.

27. A method for data transmission, the method comprising:
observing risks, with a processor; and
adjusting data transmission performance parameters according to the risks, with a processor.

28. A method for communicating information, the method comprising:
identifying at least one risk area, with a processor;
determining a current location of an entity, with a processor;
calculating a distance from the at least one risk area to the entity, with a processor; and
communicating the information with a transmitter when proximity of the entity to the at least one risk area is within a defined value.
